(19) United States
(12) Patent Application Publication
(10) Pub. No.: US 2002/0174013 A1
(43) Pub. Date: Nov. 21, 2002

(54) Chip card advertising method and system

(75) Inventors: Gary A. Freeman, Newton, MA (US); David H. Freeman, Tampa, FL (US)

Correspondence Address: G. ROGER LEE, Fish & Richardson P.C., 225 Franklin Street, Boston, MA, 02110-2804, US

(73) Assignee: Viztec Inc., a Florida corporation

(21) Appl. No.: 10/138,593

(22) Filed: May 2, 2002

Related U.S. Application Data
(63) Continuation of application No. 09/457,988, filed on Dec. 9, 1999.
Application No. 09/457,988 is a continuation-in-part of application No. 09/061,879, filed on Apr. 17, 1998, now Pat. No. 6,068,183.

(51) Int. Cl. G06F 17/60

(52) U.S. Cl. 705/14; 705/17; 705/41

(57) ABSTRACT

A method and system for providing advertisement information on chip cards, and for the distribution of the resulting revenues. It also includes tracking and storing of integrated relational information regarding advertisement information, products, and customer's buying habits with respect to those products. At the time a customer uses a chip card to purchase an item, particular advertisement information is stored onto the card based on information characterizing the customer (user). The chip card may or may not incorporate an electronic display for showing the advertisement directly on the card. Credit transactional fees are adjusted based on advertising download rates and other parameters.

### CROSS-REFERENCE TO RELATED APPLICATIONS

This application is a continuation in part of U.S. application Ser. No. 09/061,879, incorporated herein by reference. It is related to U.S. application Ser. No. ______, filed on even date herewith, entitled “Chip Card Advertising”, and U.S. application Ser. No. 09/040,517, also incorporated herein by reference.

### BACKGROUND OF THE INVENTION

This invention relates to providing advertisement information, including advertising as well as sales promotions, on chip cards (sometimes called “smart cards”), and to the distribution of the revenues generated by providing such advertisement information.

Credit Card and Chip Card Background

Credit cards developed from oil company, restaurant and department store charging accounts which predated the present electronic systems by several decades. In the 1960s and 1970s, credit card usage expanded as consumer finance was made more readily available and became an important source of revenues for banks. Credit cards are similar to debit cards (and we use “credit card” herein to refer to both); they are distinguished from debit cards by having access to a line of credit made available to the cardholder by the card issuer. They generally require four separate parties to each transaction: the cardholder, the merchant selling the goods or services, the merchant acquirer processing the credit card payment, and the card issuer. In certain cases, the merchant acquirer and credit card issuer will be the same company.

Credit cards can take the form of chip cards by the insertion of a microprocessor, memory, or both, into the card. This allows for storage and processing of data on the card itself. A stored-value chip card (sometimes termed an ‘electronic purse’ or ‘e-purse’) differs from a credit card or chip card in that the data stored on the card includes, in an encrypted format, data that represents a cash value. This stored digital cash value can be deducted from the card at the time of sale in a transaction that is strictly between the Point of Sale (POS) terminal and the stored-value chip card. At time of settlement and clearing (electronic data capture), usually conducted during off-hours, that digital cash value is transferred to the merchant's bank account via the traditional credit networks. The standard “EMV '96 Integrated Circuit Card Specification for Payment Systems Version 3.1.1 May 31, 1998” describes credit cards containing an integrated circuit (i.e. a nonstored-value chip card.) Systems have been developed for storing coupons and other sales promotions on chip cards (Powell, U.S. Pat. No. 5,806,044; Haddad, U.S. Pat. No. 5,504,806; Nemirofsky, U.S. Pat. No. 5,412,416).

Chip cards can be used in two types of operating environments: closed systems or open systems. A closed system is managed in a contained environment where there is a single card issuer, who also acts as the sole service provider. A proprietary card is issued to customers of the service provider for exclusive use at its facilities. Because the issuer, service provider, and also at times the acquirer are a single entity, there is no need for a system operator to clear transactions with other parties. Closed systems are typically used in applications such as transit systems, colleges and universities, public telephones, theme parks, military bases, prisons, and large corporations. An open system, on the other hand, accommodates multiple issuers and allows consumers to use their cards at multiple locations and merchants. Because there are multiple issuers and acquirers, an open system involves a greater degree of complexity than a closed one. An open system requires a clearing and settlement function to move funds between issuers and acquirers; demands greater security; and necessitates a standard infrastructure among all participants.

Credit Card Industry Terms

Merchant Acquiring Financial Institution—A bank or other financial institution that has a business relationship with a merchant and receives all credit card transactions from that merchant.

Card Issuing Financial Institution—A bank or other financial institution which issues credit cards to the customer.

Authorization—Approval of a credit card transaction for a merchant by the card-issuing bank.

Authorization Code—A code assigned by the card issuing bank to a credit card sale to show that the transaction is authorized.

Electronic Data Capture—Entering and processing the sales drafts by electronic methods. Typically, a credit card sale authorization is obtained at the time of the purchase, and then at night the sales draft is electronically captured by sending in batch the day's sales drafts from the Point of Sale (POS) terminal to be processed by the Acquirer. In online payment schemes, capture is used to denote the electronic deposit of the sales draft with the Acquiring bank.

Sales draft—An instrument showing an obligation on the cardholder's part to pay money, (i.e . . . the sale amount), to the card issuer. This is the piece of paper that you sign when making a purchase with your credit card.

Interchange (or transaction) Fee—A fee a credit institution charges in order to process a credit card transaction involving a cardholder's account. This fee is regulated by an institution such as MasterCard and Visa, and is a percentage of the total transaction amount. The exact definition of this will change depending on which institution is involved. (See table 1 below).

Discount (or disbursement) fee—A percentage of the retail sale paid as a fee to a credit institution for processing the credit card transaction. The exact definition of this will change depending on which institution is involved. (See table 1 below).

TABLE 1

| | Acquirer-to- | Issuer-to-Network | Network Operator- |
|---|---|---|---|
| | Merchant | Operator | to-Acquirer |
| Transaction Fee | The price per | The price per | The price per |
| | transaction that an | transaction that an | transaction that a |
| | acquirer charges a | issuer charges a | network operator |
| | merchant to process a | network operator to | charges an acquirer |
| | transaction | process a transaction | to process a |
| | | | transaction |
| Disbursement | The percent of each | The percent of each | The percent of each |
| (discount) Fee | dollar spent that an | dollar spent that an | dollar spent that a |
| | acquirer charges to a | issuer charges to a | network operator |
| | merchant to process a | network operator to | charges to an |
| | transaction | process a transaction | acquirer to process a |
| | | | transaction |

Advertising Background

Traditional advertising media, such as newspaper, billboard, radio, magazine and television, have focused on delivering advertising messages to mass audiences that are defined by broad demographic descriptors such as age, gender, median family income, education level, etc. On a limited basis, efforts have been made to target advertising to subpopulations within the larger demographic groups (Wachob, U.S. Pat. No. 4,155,591; Carles, U.S. Pat. No. 5,515,098; Dedrick, U.S. Pat. No. 5,724,521; Saxe, U.S. Pat. No. 5,636,346), but with limited success. Targeting the advertising to the specific consumer or consumer group improves the success of that particular advertising. Internet advertising allows for a more focused advertising based on either login information provided by the user within local domains, or the specific type of site, e.g., an ad for fishing tackle on a website devoted to fishing, or on network information such as internet service provider (ISP) location, time of day, or on inferential data gathered as the user ‘surfs’ around a particular site or sites (Alberts, U.S. Pat. No. 5,937,392; Angles, U.S. Pat. No. 5,933,811; Merriman, U.S. Pat. No. 5,948,061). But as with traditional advertising, with internet advertising there is still no direct link between the advertisement and the purchase, thus the auditable results of internet advertising still do not measure purchases versus the advertising program.

### SUMMARY OF THE INVENTION

We have discovered a method for using chip cards as a vehicle for delivering advertisement information to consumers. Preferably, our invention is used to deliver targeted advertisement information. It is based on demographics, psychographics, and other customer preference information that is verifiable and auditable. The advertisement information can be context sensitive, e.g., that if you are currently involved in purchasing audio equipment, you don't get an ad for toothpaste. The results of an advertising campaign are auditable and provide more than just a measure of the rate at which users click on a particular internet advertising banner, but instead provide a measure of whether or not the advertisement information resulted in additional sales leads, sales, or other traditional measures of advertising return on investment (ROI). The invention has a method for tracking and measuring the impact of frequency, i.e. the number of times an advertisement should be displayed to a particular customer before reaching the point of diminishing returns.

The invention provides a method for electronically distributing advertisement information, by which we mean both advertising and sales promotions (see copending U.S. Ser. No. ______, filed on even date herewith, entitled “Chip Card Advertising”, for a fuller discussion). The specific content of the advertisement information is preferably targeted to the consumer based on information either stored on the chip card or residing on the transaction network. The invention also includes methods of tracking and storing of information relating the advertisement information to the user (customer), the products purchased, the number of times the advertisement information is displayed prior to a purchase, and other relevant purchasing habits of the user (customer).

The system preferably includes a plurality of cards incorporating integrated circuits (“chip cards”); one or more point of sale (POS) terminals which communicate with the chip cards at the time of sale; a first computer network capable of communicating with the POS terminals via a communication channel such as standard telephone lines or Ethernet-based local area networks (LAN's), or wide-area networks (WAN's) typically termed the “merchant acquirer network” or “Acquirer”; a second computer network capable of communicating with the Acquirer via the communication channels just mentioned, and bills the consumer for any credit charges—typically termed the “Card Issuer” or “Issuer”; a third computer network capable of communicating with both the Acquirer and Issuer networks and which manages the process of collecting storing and distributing the advertising content—termed the “Advertising Affinity Operator” or “Affinity Operator”; and the Advertiser generating the advertisement information.

At the time a customer uses a chip card in a transaction (e.g., to purchase an item), particular advertisement information is downloaded onto the card, with the selection of advertisement information preferably based on information characterizing the user. The advertisement may be served either directly from the POS terminal or in-store network or from the Affinity Operator's advertising server. In the case where the advertisement is downloaded from an advertising server residing at or in the vicinity of the merchant location (e.g., in the POS terminal or the merchant's computer network), the advertisement information would be downloaded ahead of time from the Affinity Operator's server, preferably during the settlement and clearing operations conducted during a prior off-hours period. Decision rules for choosing which advertisement information to download onto a user's card would also be downloaded ahead of time, preferably during a prior settlement and clearing period. Information characterizing the user (or customer, which we use interchangeably with user) is stored on the chip card, which allows the advertising server to determine which advertisement information is most appropriate for that particular customer. The types of items currently being purchased by the customer as well as the merchant type may be combined with the information characterizing the user to determine which ad is downloaded to the chip card. The chip card may or may not incorporate an electronic display for showing the advertisement directly on the card. If no display is provided, the advertisement information may be displayed on a device with which the chip card communicates. The advertisement information is stored as a text, sound, graphics, or video files (such as JPEG or MPEG) or as a pointer (e.g., a URL to an Internet site that has the advertisement). Revenue received by the Affinity Operator from advertisers may be shared with the merchant and other entities in the transactional network, by adjusting credit transactional fees based on download rates and other parameters (e.g., by discounting the fees in relation to the number of advertisements downloaded onto chip cards).

In the case of ATM ‘cash machines’, the ATM may allow for customer input regarding the type of product about which the customer is interested in receiving advertising and discounts on the ATM display during the time that the customer is waiting for the transaction to be processed.

When the purchase is made over the Internet, the customer could have a chip card reader connected to their personal computer. Since the bandwidth of the communication channel is likely to be sufficient to support real time download of at least text, sound, and graphics images (and short video files in the case of data rates higher than 100 kbps), the advertising server may be located on the Affinity Operator's network. Information characterizing the customer can be entered and stored either on the customer's personal computer or on the Affinity Operator's network.

In general the invention features a method for providing advertisement information in connection with the use of a chip card of the type containing a memory, the method comprising: storing user identification information in the memory of the chip card for identifying the user of the card; downloading advertisement information onto the chip card when the card is used by the user; storing the advertisement information on the chip card; and displaying the advertisement information either on a display built into the card or on a display on a device with which the card communicates.

Implementations of the invention may incorporate one or more of the following features:

The advertisement information stored on the chip card may be the advertisement information, itself, or an address or hyperlink (e.g., URL) to a location where the advertisement information is stored on a network with which the card communicates. The address or hyperlink may be associated with a thumbnail of the actual advertisement information. The thumbnail may have enough content to, itself, be advertisement information, or it may constitute only a hyperlink to the advertisement informaton.

The advertisement information downloaded to the chip card may be selected from a plurality of possible advertisement information, and the selection may be based at least in part on information characterizing the user.

The selection may be based at least in part on at least some of the user identification information stored on the card.

The downloading of the advertisement information onto the chip card may occur in connection with a transaction. The transaction may be a purchase made using the chip card to pay for the purchase. The purchase may be made at a POS terminal. The purchase may be of communication services using a card adapted to purchase the communication services. The communication services may comprise telephone service, and the chip card may be a telephone calling card. The purchase may be usage of a toll road, and the purchase may be made by wireless communication with the chip card as a vehicle containing the card passes a location on the toll road. Information identifying the downloaded advertisement information may be downloaded onto the chip card. At least some of the information characterizing the user may be stored in the memory of the chip card, or at least some of the information characterizing the user may be stored on a computer network to which the chip card can be connected. Stored on the chip card may be information representative of the number of times that the advertisement information has been displayed. Stored on the chip card may be information representative of whether the chip card has been used to purchase a product or service related to the advertisement information downloaded onto the chip card. Stored on the chip card may be information representative of whether the chip card has been used to purchase a product or service related to the advertisement information downloaded onto the chip card, and information representative of the number of times that the advertisement information has been displayed prior to the time of the purchase. The information can be stored on a computer network to which the chip card can be connected, or in a memory on the chip card as part of an affinity record.

The method may include downloading to the chip card information identifying the downloaded advertisement information; relating in a database the information identifying the downloaded advertisement information, the information representative of the number of times that the advertisement information has been displayed, and the information representative of whether the chip card has been used to purchase a product or service related to the advertisement information downloaded onto the chip card. This information may be related to information representative of the number of times that the advertisement information has been displayed prior to the time of the purchase. The information may be stored on the chip card, and may be uploaded from the chip card to the database, which resides on a computer network. The uploading of the information from the chip card may occur at the time the chip card is used in a transaction, or during the settlement and clearing operation performed following a transaction.

The method may include operating an advertising distribution service that receives advertisement information from advertisers, stores the advertisement information on a computer system connected to a computer network, and downloads the advertisement information over the computer network to the chip card.

The advertisement information may be downloaded to merchants in advance of downloading of the advertisement information to the chip card, the merchants may store the advertisement information locally, and the advertisement information may be downloaded, from the local storage, to the chip card at the time that the user enters into a transaction with the merchant. The advertisement information may be stored remotely from a merchant, and downloaded to the merchant and to the chip card at the time that the user enters into a transaction with the merchant. The transaction between the user and the merchant may occur over a computer network such as the Internet. The transaction between the user and the merchant may occur in an establishment to which the user physically travels. The transaction may occur at a POS terminal. The advertising distribution service may receive revenue for distributing the advertisement information, and may share a portion of the revenue with the merchant. The amount of advertising revenue shared with he merchant may be based generally on the number of times that the advertisement information is downloaded to a chip card.

The revenue may be shared with one or more of the following additional parties: merchant acquirer, network operator, and chip card issuer. The revenue may be shared with other parties by discounting fees that the party pays in connection with the user entering into a transaction using the chip card. The revenue may be shared with other parties by payments made by the advertising service to the party.

The advertising distribution service may receive user profile information that includes at least demographic information about the user. The user profile information for a user may be used in deciding which of a plurality of advertisement information is downloaded to the chip card of that user.

The advertising distribution service may receive information over the computer network representative of the number of times that the advertisement information has been displayed, may relate the information to the advertisement information, and may provide tracking information to the advertiser.

The tracking information related to the advertisement information may further include information indicating whether a product related to the advertisement information has been purchased using the chip card.

The tracking information related to the advertisement information may further include user profile information that contains at least demographic information about the user.

The user profile information may further include psychographic information about the user.

An advertising testing campaign may be conducted in which a plurality of advertisement information for the same product or service are distributed, loaded onto chip cards, and user profiles and information on number of times of display and on purchase may be and may be uploaded from the chip cards for the ads, and the information may be processed to determine which of the advertisement information should be used, or which of the advertisement information should be used with particular user profiles.

The chip card may have a flexible electronic display for displaying the advertisement information.

The information characterizing the user may comprise a multi-dimensional description of the user based on demographic, psychographic, or other customer preference data.

The advertisement information downloaded to the chip card may be based on the information characterizing the customer uploaded from the chip card, a set of decision rules, and data indicating the preferred customer type to receive the particular advertisement information.

A decision rule may be used in selecting the advertisement information to be downloaded, and the decision rule may be based on the distance in an n-dimensional user profile descriptor space between the user profile and a target profile for the advertisement information.

The decision rule may include a quota system, by which the total number of downloads of advertisement information to the chip card by a particular POS or other server is limited to a predetermined maximum.

The affinity operator may develop a set of decision rules to determine which advertisement information should be downloaded onto a user's card.

The affinity operator may collect user profile data, information identifying the advertisement information, and affinity records, incorporate the data into a database, and processed data contained within the database to develop and, on an ongoing basis, refine a predictive model of purchasing performance based on information contained with the database.

The information stored on the chip card may contain information identifying the specific product manufacturer or vendor, a product identification, and an indicator of how many displays of the advertisement information were performed prior to the customer's first purchase of the item or items advertised.

Stored on the card may be a value that indicates the generic class or classes into which a particular product falls.

Stored on the card may be a value that indicates a price range into which the selling price of a particular product falls.

Stored on the card may be a value that indicates the version of the advertising information downloaded to the card to distinguish from among a plurality of versions of the advertising information, each of the versions targeted to a different user type.

The information characterizing the user comprises a user profile generated from demographic, psychographic, or other specific product preference information along with a user identification.

The user identification may be encoded to hide the identity of the user from a database used for tracking the purchasing activity of the user.

The encoding may be done so that there exists a substantially one-to-one mapping between the encoded user identification and the actual user identification.

The user identification information may be a credit or debit card number. The card type and card issuer fields of the user identification information may be left unencoded.

The transaction may be a purchase-less transaction such as an ATM transaction.

The advertisement information may be advertising.

The advertisement information may be one or more sales promotions.

The advertisement information may be stored in a memory stored within the display.

The advertisement information may be stored in a memory on the chip card separate from the display.

At least one decision rule used to select advertisement information for downloading may be based on the current date or time, so that advertisement information can be downloaded at relevant dates or times, e.g., at times at which advertising might be most persuasive (e.g., just prior to a stored birthday, or during a promotional period).

Advantages of the invention can include one or more of the following. The invention provides for the first time a method of measuring the effectiveness of advertisement information, and directly correlating purchases to such advertisement information. It also provides a method of automatically distributing advertising revenues to the various parties via electronic financial transaction networks.

Other features and advantages of the invention will be apparent from the following description, including the figures, and from the claims.

### BRIEF DESCRIPTION OF THE DRAWINGS

FIG. 1 is a flow diagram of a process for storing advertisement information on a chip card and distributing resulting revenue to the various parties involved in the transaction.

FIG. 2 is a diagram of a typical retail application with a point-of-sale (POS) terminal.

FIG. 3 is a diagram of a typical online application with personal computer and chip card reader.

FIG. 4 is a drawing of a chip card with display showing both kinds of advertisement information: advertising and a sales promotion.

FIG. 5 is a diagram of the chip card architecture and electrical interface

FIG. 6 is a description of the advertising affinity data structure stored on the chip card.

FIG. 7 is a description of the individual advertising data structure which makes up the affinity data block shown in FIG. 6.

### DETAILED DESCRIPTION

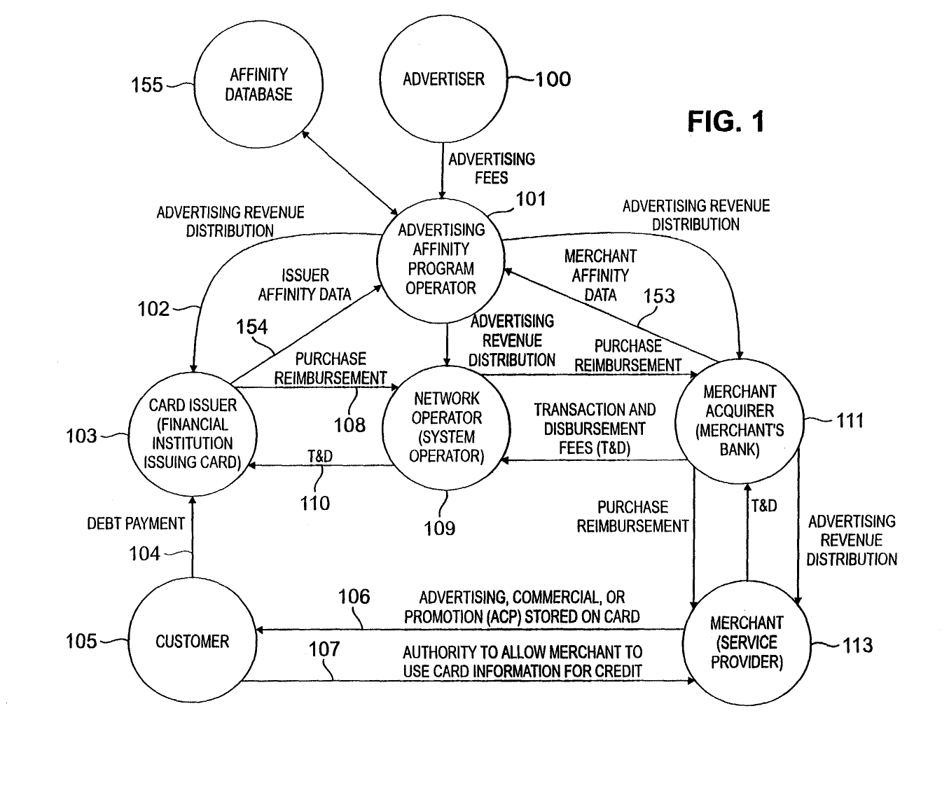

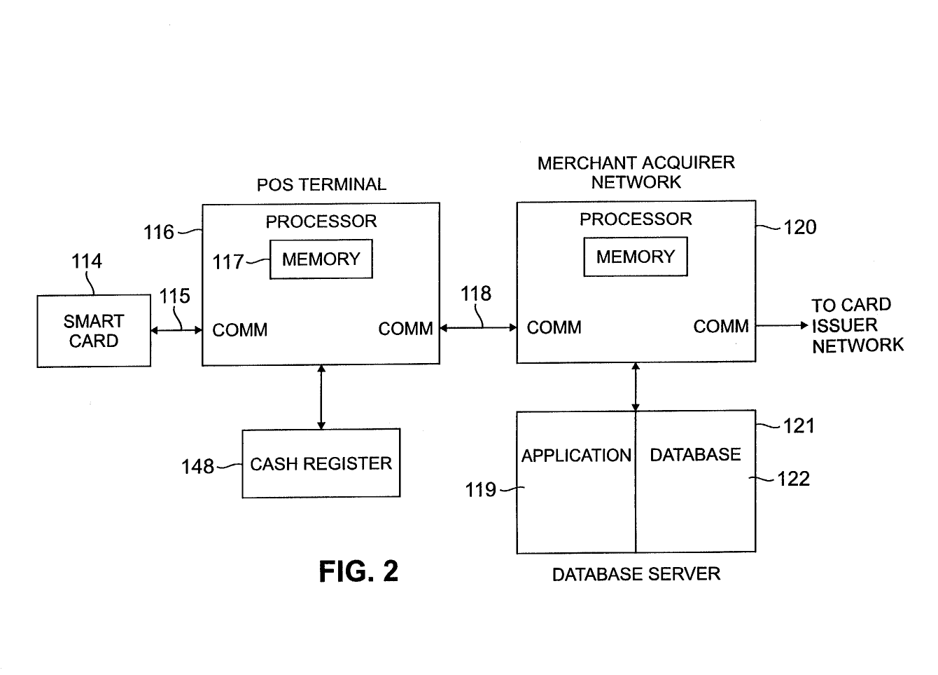

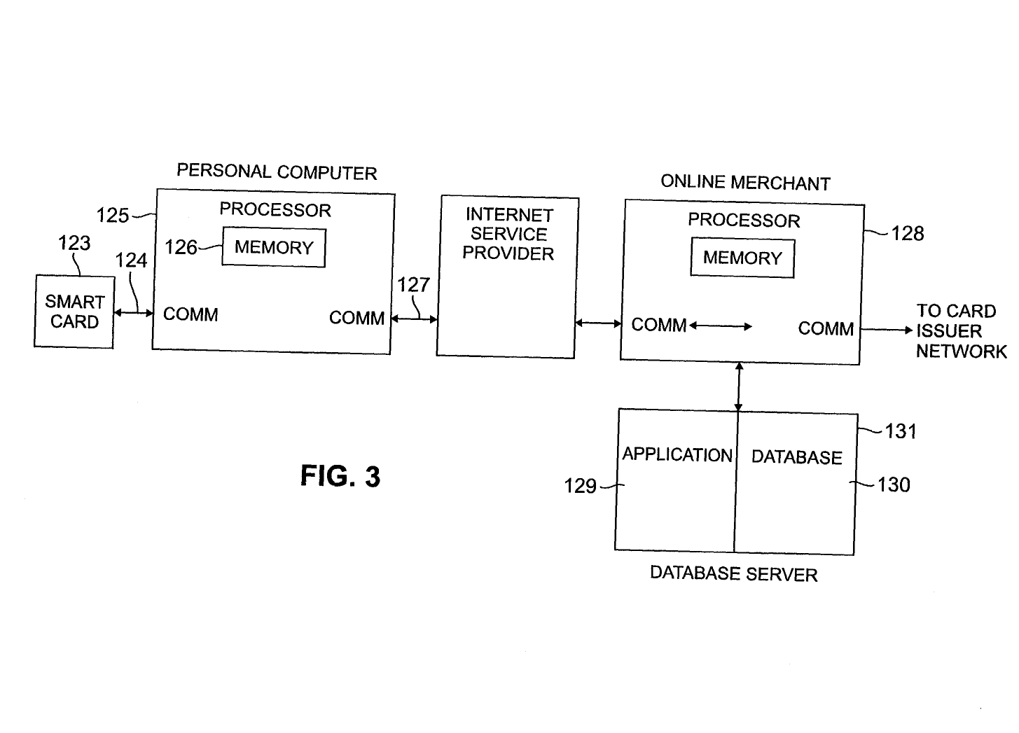

Referring to FIGS. 1 and 2, a system stores advertisement information 106 on a chip card 123 when a consumer 105 visits a merchant 113 at either an on-line or retail store and purchases an item using the chip card. By “advertisement information” we mean advertising (e.g., a still image or a moving image, and/or an audio recording) or a sales promotion (e.g., a coupon).

Advertisement information 106 can take the form of an electronic coupon that includes a product UPC (Universal Product Code) and a discount value; it can include text, graphics (e.g., JPEG (Joint Picture Experts Group), and video (e.g., MPEG (Motion Picture Experts Group) for still or moving advertisements (commercials), and sound for presentation either on the chip card, on a computer monitor, or on a chip card reader display. The advertisement information can also include a hypertext link and/or an HTML (Hypertext Markup Language) document. The links can transfer a consumer to a business' on-line store when a browser (e.g., Microsoft Internet Explorer) presents the link or HTML document. This feature enables less Internet-savvy consumers to easily navigate to a business' web-site.

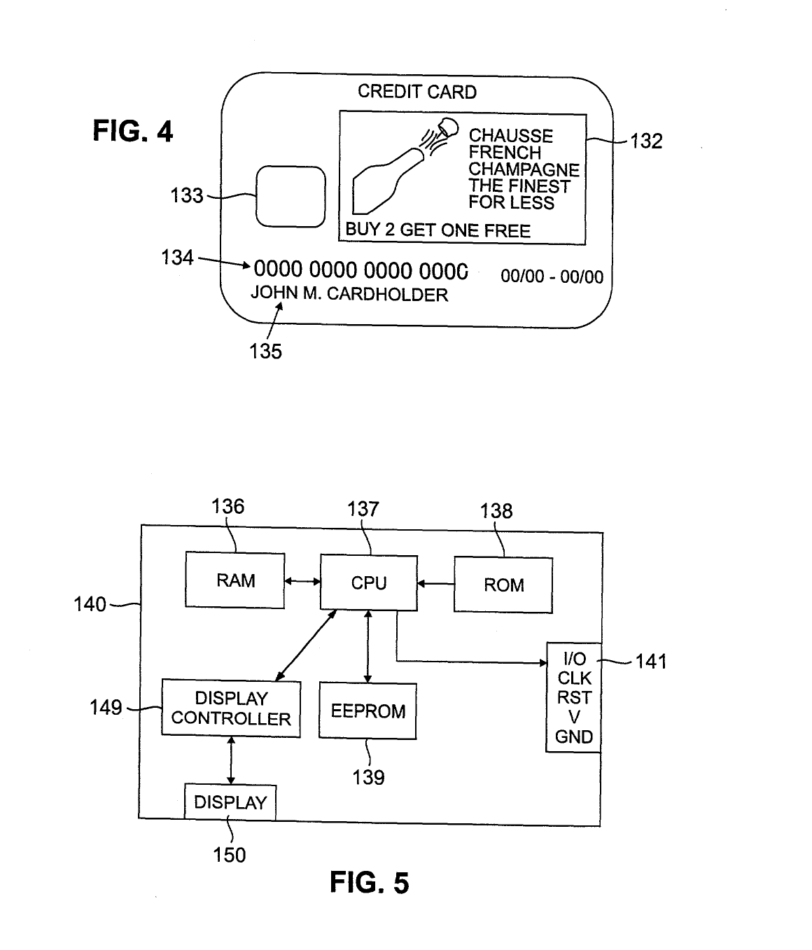

Referring to FIGS. 4 and 5, a chip card 140 includes memory 139 for storing information for one or more instances of advertisement information 106. A chip card 140, such as the chip card described in co-pending U.S. Ser. No. 09/040,517 can also include a display. Such a chip card can display advertising as well as sales promotion information to a user (e.g., provide a continual reminder to redeem an electronic coupon). The advertisement information can alternatively be stored in memory within the display itself.

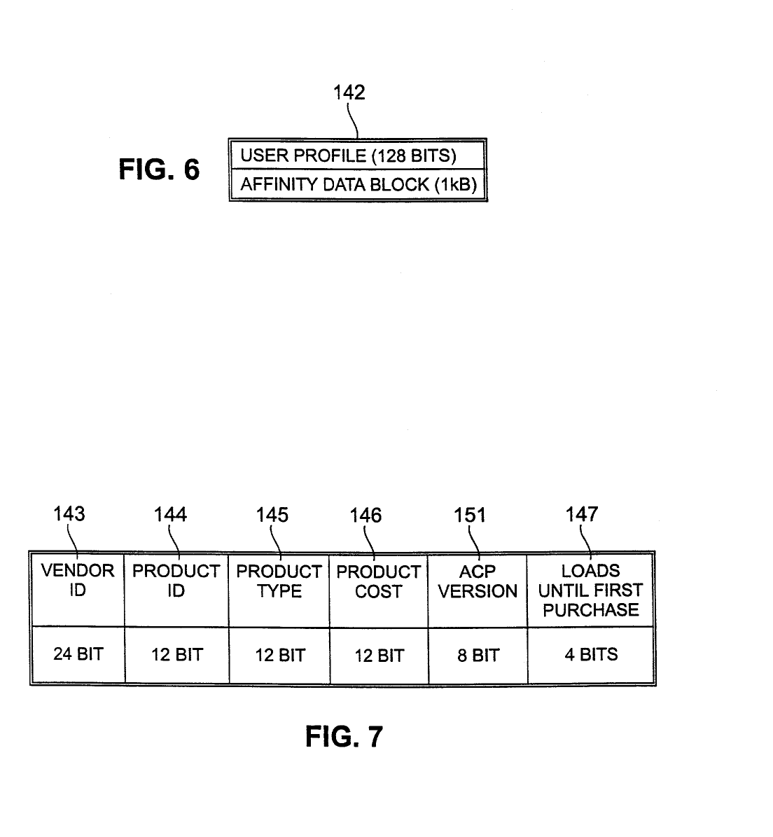

At the time of a transaction, e.g., purchase, the Merchant 113 calculates the amount of purchase and asks the consumer 105 for payment. The Merchant 113 inserts the chip card 114 into the POS terminal 116 and communication is established between the chip card 114 and the terminal 116 via serial data channel 115. Referring to FIGS. 4-6, the serial communication channel is accomplished by electrical contacts 133 and communication signals 141 of the chip card 114. The amount of the sale is either hand-entered or transmitted by the cash register 148. Referring to FIG. 6, the USER PROFILE data field 142 is transferred from the chip card 114 to the POS terminal 116.

The USER PROFILE data field 142 (information characterizing the card user) is preferably 128 bits long and is composed of preferably 4 bit fields, each representing a value or numeric score for the user relative to a specific demographic, psychographic, or other measure; there is additionally a preferably 8 bit field which represents the version number of the USER PROFILE data structure for use by the advertising server's decision-making algorithm. In the case of a 128 bit word with 4 bit fields, the USER PROFILE data field 142 provides a 30-dimensional descriptor matrix of the factors affecting a customer's buying habits. Based on traditional marketing techniques such as customer interviews and questionnaires and focus groups, a user profile or set of profiles will be developed that are believed to be the optimum group to which the chip card advertisement information should be targeted. Additionally, the advertiser may wish to test market to other user profiles that may have produced equivocal results by traditional marketing, but which the advertiser wishes to gather actual data using the chip card advertisement information. As shall be explained in more detail, actual preference data for the advertisement information will be gathered on the chip card during customer purchases and transmitted to the Affinity Operator's database server. Using standard statistical analysis tools such as multiple regression analysis, non-linear factor analysis, classification and regression trees and other methods along with other data visualization tools, traditional marketing techniques can be supplemented and re-evaluated based on models generated from the data in the Affinity Network database. Based on the above-mentioned methods, the target user profile or profiles are chosen by the Advertiser 100 in conjunction with the Affinity Operator 101. Not all 30 dimensions of the user profile may be relevant, and moot variables can be flagged to be ignored. Based on these user profiles a calculation is made, preferably by the POS terminal processor 116 in the case of a retail merchant, to determine, preferably, the mean square difference between the customer's USER PROFILE 142 and the relevant dimensions of each advertisement's target profiles. The advertisement information with the least mean square difference is chosen to be loaded onto the chip card 114. A quota may be specified for the total number of downloads for a particular advertisement per day; if that quota is reached at a particular POS terminal 116 then that particular advertisement might not be considered as a candidate for download. Additionally, target profiles may include such non-customer-related factors as the nature of the items currently being purchased by the customer; for instance, if the customer were purchasing a loaf of bread, the advertisement information downloaded might be one for a related item like butter, or it might be for a competitor's bread.

Merchant 113 transmits the credit card data and sales amount with a request for authorization of the sale to their Acquirer 111 or Network Operator 109, if there is one, typically by phone line but sometimes by Internet. The Network Operator 109, if present, performs settlement and clearing functions, enforces rules and regulations, handles security issues, and maintains the float pool. Point of sale units 116 are usually set to request authorization at the time of sale, and then actually capture the sales draft at a later time. The Acquirer 111 that processes the transaction also routes the authorization request to the Issuer 103. The credit card number identifies type of card, issuing financial institution, and the cardholder's account (user identification information). If the cardholder has enough credit in their account to cover the sale, the Issuer 103 authorizes the transaction and generates an authorization code. This code is sent back to the Acquirer 111. The Issuer 103 puts a hold on the cardholder's account for the amount of the sale. The Acquirer 111 processes the transaction and then sends the approval or denial code to the merchant's point of sale unit 116. During the time that these preceding transactions are taking place to obtain authorization, the POS terminal 116 downloads the chosen advertisement to the chip card. A new Affinity record is created in the Affinity data block on the chip card containing the VENDOR ID 143, PRODUCT ID 144, PRODUCT TYPE 145, ADVERTISEMENT VERSION 151, PRODUCT COST 146, and LOADS UNTIL PURCHASE 147 fields associated with that particular advertisement. There may be more than one version of the advertisement for a particular product for reasons of targeting the message to particular customer groups, therefore a data field is provided, ADVERTISEMENT VERSION 151, which indicates which advertisement has been downloaded. Additionally, the chip card's Affinity Records are uploaded to the POS terminal 116 and compared to items currently being purchased. If a match is found between the PRODUCT ID 144 and any of the purchased product's UPC's, then the following algorithm is performed:

If match then

If (PURCHASED==FALSE) then *if it hasn't yet been purchased*

{if LOADS_UNTIL_FIRST_PURCHASE<7 then

LOADS_UNTIL_FIRST_PURCHASE++;

PURCHASED==TRUE;
}

else *no match to ACP*

{if LOADS_UNTIL_FIRST_PURCHASE<7 then

LOADS_UNTIL_FIRST_PURCHASE++;

}

The data value LOADS_UNTIL_FIRST_PURCHASE is the number of downloads of that particular advertisement that were needed before a purchase was first made by the card holder. The Affinity Record for the particular advertisement that was loaded to the card along with the credit card number is saved in POS memory for upload to the Affinity Operator 101 or Acquirer 111 during subsequent electronic data capture.

The POS terminal 116 or cash register 148 prints out a sales draft, or slip. The merchant asks the Customer 105 to sign the sales draft, which obligates them to reimburse the Issuer 103 for the amount of the sale. At a later time, probably that night when the Merchant 113 is closing up, the merchant reviews all the authorizations stored in the POS terminal 116 against the signed sales drafts. When all the credit card authorizations have been verified to match the actual sales drafts, the merchant undertakes a settlement and clearing process in which the merchant ‘captures’, or transmits, the data on each authorized credit card transaction to the Acquirer 111 for deposit. This is in lieu of depositing the actual signed paper drafts with the Acquirer 111. The Acquirer 111 performs what is called an interchange for each sales draft, with the appropriate Issuer 103. The Issuer 103 transfers the amount of the sales draft, minus a transaction and disbursement fee 110 to the Acquirer 111. The Acquirer 111 then deposits the amount of all the sales drafts submitted by the merchant 113, less a discount fee (e.g., proportional to the volume of advertisement information the merchant has downloaded onto chip cards), into the merchant's bank account.

On a regular basis, and preferably at the time of electronic data capture (settlement and clearing), the Merchant 113 will transmit all the Affinity Records and associated card numbers stored on the retail location's POS terminals 116 preferably to the Acquirer 111. Prior to sending the data on to the Affinity Operator 101, the Acquirer 111 preferably encrypts the credit card number using application software 119 residing on the Acquirer's Database server 121 so that the cardholder's identity and account information remain unknown to the Affinity Operator 101. By using the appropriate encryption algorithm, e.g. a symmetric key algorithm like IDEA (International Data Encryption Algorithm) or Triple DES (Data Encryption Standard) with a key known only to the Acquirer 111 and Issuer 103, the cardholder information can be hidden from the Affinity Operator 101. In the preferred embodiment, the Acquirer removes the leading digits of the credit card number which identify the card type (e.g. VISA, MasterCard, American Express) and Issuer ID number, and then proceeds to encrypt the remaining digits of the card number using the appropriate encryption algorithm. The Acquirer then appends the Card type and Issuer ID number back onto the cipher text and transmits this, along with the Affinity Record, to the Affinity Operator 101. The Acquirer 111 repeats this for all Affinity Record/card number pairs.

As part of the data transfer protocol between the Acquirer 111 and Affinity Operator 101, the Acquirer identifies itself by its assigned ID number prior to transferring data to the Affinity Operator. The Affinity Operator 101 uses this ID along with the Affinity Record/card number pairs to create records in its Affinity Database 155. The Affinity Database records contain fields for at least the following information: Date of advertisement download; card type; issuer ID; acquirer ID; encrypted cardholder ID (one form of user identification information); Product vendor ID; Product type; Product cost; Loads until first purchase; advertisement version; and User profile. Also included in the data transfer protocol is an acknowledgement of receipt message from the Affinity Operator 101 to the Acquirer 111 that indicates the number of records received. Based on the acknowledged number of records received, the Affinity Operator 101 makes payment to the Acquirer 111 on a preferably per record basis of an amount mutually agreed to by both parties. The payment may be made at the time of data transfer via financial electronic data interchange (EDI), via money transfer using the National Automated Clearing House Association, or by conventional paper check at a later time. There will be multiple Acquirers participating in the download of advertisement 106 onto chip cards 123; the total number of downloads for each advertisement across all Acquirers is tallied and the Affinity Operator 101 charges the Advertiser 100 based on that total.

Application software resides on the Issuer's Network which transforms the cardholder data residing on the Issuer Network into the previously mentioned 128 bit USER PROFILE 142 data. On a regular basis the Issuer 103 will transmit any USER PROFILE 142 updates to the Affinity Operator 101. Prior to sending the data on to the Affinity Operator 101, the Issuer 103 preferably encrypts the credit card number so that the cardholder's identity and account information remain unknown to the Affinity Operator 101. By using the appropriate encryption algorithm, e.g. a symmetric key algorithm like IDEA (International Data Encryption Algorithm) or Triple DES (Data Encryption Standard) with a key known only to the Acquirer 111 and Issuer 103, the cardholder information can be hidden from the Affinity Operator 101. In the preferred embodiment, the Issuer removes the leading digits of the credit card number which identify the card type (e.g. VISA, Mastercard, American Express) and Issuer ID number, and then proceeds to encrypt the remaining digits of the card number using the appropriate encryption algorithm. The Issuer then appends the Card type and Issuer ID number back onto the ciphertext and this, along with the USER PROFILE 142 is sent to the Affinity Operator 101. The Issuer 103 repeats this for all USER PROFILE/card number pairs. Based on the acknowledged number of records received, the Affinity Operator 101 makes payment to the Issuer 103 on a preferably per record basis of an amount mutually agreed to by both parties. The payment may be made at the time of data transfer via financial electronic data interchange (EDI), via money transfer using the National Automated Clearing House Association, or by conventional paper check at a later time.

As part of the data transfer protocol between the Issuer 103 and Affinity Operator 101, the Issuer identifies itself by its assigned ID number prior to transferring data to the Affinity Operator 101. The Affinity Operator 101 uses this ID along with the USER PROFILE/card number pairs to update records in its Affinity Database 155.

What is claimed is:

1. A method for providing advertisement information in connection with the use of a chip card of the type containing a memory, the method comprising:
storing user identification information in the memory of the chip card for identifying the user of the card;
downloading advertisement information onto the chip card when the card is used by the user;
storing the advertisement information on the chip card; and
displaying the advertisement information either on a display built into the card or on a display on a device with which the card communicates.

2. The method of claim 1 wherein the advertisement information stored on the chip card comprises an address or link to advertisement information located on a network with which the card communicates.

3. The method of claim 2 wherein a thumbnail is stored on the chip card, and the thumbnail comprises the address or link.

4. The method of claim 3 wherein the thumbnail contains sufficient content to provide actual advertisement information.

5. The method of claim 1 wherein the advertisement information stored on the chip card comprises the actual advertisement information.

6. The method of claim 2 or 5 wherein the advertisement information downloaded to the chip card is selected from a plurality of possible advertisement information, and the selection is based at least in part on information characterizing the user.

7. The method of claim 6 wherein the selection is based at least in part on at least some of the user identification information stored on the card.

8. The method of claim 2 or 5 wherein the advertisement information is displayed on the display built into the card.

9. The method of claim 2 or 5 wherein the advertisement information is displayed on the device with which the card communicates.

10. The method of claim 2 or 5 wherein downloading of the advertisement information onto the chip card occurs in connection with a transaction.

11. The method of claim 10 wherein the transaction is a purchase made using the chip card to pay for the purchase.

12. The method of claim 11 wherein the purchase is made at a POS terminal.

13. The method of claim 11 wherein the purchase is of communication services using a card adapted to purchase the communication services.

14. The method of claim 13 wherein the communication services comprise telephone service, and the chip card is a telephone calling card.

15. The method of claim 11 wherein the purchase is usage of a toll road, and the purchase is made by wireless communication with the chip card as a vehicle containing the card passes a location on the toll road.

16. The method of claim 2 or 5 wherein information identifying the downloaded advertisement information is downloaded onto the chip card.

17. The method of claim 6 wherein at least some of the information characterizing the user is stored in the memory of the chip card.

18. The method of claim 6 wherein at least some of the information characterizing the user is stored on a computer network to which the chip card can be connected.

19. The method of claim 2 or 5 further comprising storing information representative of the number of times that the advertisement information has been displayed.

20. The method of claim 2 or 5 further comprising storing information representative of whether the chip card has been used to purchase a product or service related to the advertisement information downloaded onto the chip card.

21. The method of claim 19 further comprising
storing information representative of whether the chip card has been used to purchase a product or service related to the advertisement information downloaded onto the chip card; and
storing information representative of the number of times that the advertisement information has been displayed prior to the time of the purchase.

22. The method of claim 21 wherein the information is stored in the memory of the chip card.

23. The method of claim 21 wherein the information is stored on a computer network to which the chip card can be connected.

24. The method of claim 22 wherein the information is stored in the memory of the chip card as part of an affinity record.

25. The method of claim 6 further comprising
storing information representative of the number of times that the advertisement information has been displayed; and
storing information representative of whether the chip card has been used to purchase a product or service related to the advertisement information downloaded onto the chip card.

26. The method of claim 25 further comprising
downloading to the chip card information identifying the downloaded advertisement information;
relating in a database the information identifying the downloaded advertisement information, the information representative of the number of times that the advertisement information has been displayed, and the information representative of whether the chip card has been used to purchase a product or service related to the advertisement information downloaded onto the chip card.

27. The method of claim 26 further comprising relating the information recited in claim 22 to information representative of the number of times that the advertisement information has been displayed prior to the time of the purchase.

28. The method of claim 27 wherein the information is stored on the chip card.

29. The method of claim 22 wherein the information is uploaded from the chip card to a database residing on a computer network.

30. The method of claim 26 wherein the information is uploaded from the chip card to the database, which resides on a computer network.

31. The method of claim 30 wherein the uploading of the information from the chip card occurs at the time the chip card is used in a transaction.

32. The method of claim 30 wherein the uploading of the information to the database occurs during the settlement and clearing operation performed following a transaction.

33. The method of claim 6 further comprising operating an advertising distribution service that receives advertisement information from advertisers, stores the advertisement information on a computer system connected to a computer network, and downloads the advertisement information over the computer network to the chip card.

34. The method of claim 33 wherein the advertisement information is downloaded to merchants in advance of downloading of the advertisement information to the chip card, the merchants store the advertisement information locally, and the advertisement information is downloaded, from the local storage, to the chip card at the time that the user enters into a transaction with the merchant.

35. The method of claim 33 wherein the advertisement information is stored remotely from a merchant, and downloaded to the merchant and to the chip card at the time that the user enters into a transaction with the merchant.

36. The method of claim 34 wherein the transaction between the user and the merchant occurs over a computer network such as the Internet.

37. The method of claim 35 wherein the transaction between the user and the merchant occurs over a computer network such as the Internet.

38. The method of claim 34 wherein the transaction between the user and the merchant occurs in an establishment to which the user physically travels.

39. The method of claim 35 wherein the transaction between the user and the merchant occurs in an establishment to which the user physically travels.

40. The method of claim 37 wherein the transaction occurs at a POS terminal.

41. The method of claim 33 wherein the advertising distribution service receives revenue for distributing the advertisement information, and shares a portion of the revenue with the merchant.

42. The method of claim 34 wherein the advertising distribution service receives revenue for distributing the advertisement information, and shares a portion of the revenue with the merchant.

43. The method of claim 35 wherein the advertising distribution service receives revenue for distributing the advertisement information, and shares a portion of the revenue with the merchant.

44. The method of claim 39 wherein the amount of advertising revenue shared with the merchant is based generally on the number of times that the advertisement information is downloaded to a chip card.

45. The method of claim 39 wherein the revenue is shared with one or more of the following additional parties: merchant acquirer, network operator, and chip card issuer.

46. The method of claim 45 wherein revenue is shared with other parties by discounting fees that the party pays in connection with the user entering into a transaction using the chip card.

47. The method of claim 45 wherein revenue is shared with other parties by payments made by the advertising service to the party.

48. The method of claim 33 wherein the advertising distribution service receives user profile information that includes at least demographic information about the user.

49. The method of claim 48 wherein the user profile information for a user is used in deciding which of a plurality of advertisement information is downloaded to the chip card of that user.

50. The method of claim 33 wherein the advertising distribution service receives information over the computer network representative of the number of times that the advertisement information has been displayed, relates the information to the advertisement information, and provides tracking information to the advertiser.

51. The method of claim 50 wherein the tracking information related to the advertisement information further includes information indicating whether a product related to the advertisement information has been purchased using the chip card.

52. The method of claim 51 wherein the tracking information related to the advertisement information further includes user profile information that contains at least demographic information about the user.

53. The method of claim 52 wherein the user profile information further includes psychographic information about the user.

54. The method of claim 50 wherein an advertising testing campaign is conducted in which a plurality of advertisement information for the same product or service are distributed, loaded onto chip cards, and user profiles and purchase information is uploaded from the chip cards for the ads, and the information is processed to determine which of the advertisement information should be used, or which of the advertisement information should be used with particular user profiles.

55. The method of claim 2 or 5 wherein the chip card has a flexible electronic display for displaying the advertisement information.

56. The method of claim 6 wherein the information characterizing the user comprises a multi-dimensional description of the user based on demographic, psychographic, or other customer preference data.

57. The method of claim 6 wherein the advertisement information downloaded to the chip card is based on the information characterizing the customer uploaded from the chip card, a set of decision rules, and data indicating the preferred customer type to receive the particular advertisement information.

58. The method of claim 57 wherein a decision rule is used in selecting the advertisement information to be downloaded, and the decision rule is based on the distance in an n-dimensional user profile descriptor space between the user profile and a target profile for the advertisement information.

59. The method of claim 58 wherein the decision rule includes a quota system, by which the total number of downloads of advertisement information to the chip card by a particular POS or other server is limited to a predetermined maximum.

60. The method of claim 58 wherein an affinity operator develops a set of decision rules to determine which advertisement information should be downloaded onto a user's card.

61. The method of claim 6 wherein an affinity operator collects user profile data, information identifying the advertisement information, and affinity records, incorporates the data into a database, and processes data contained within the database to develop and, on an ongoing basis, refine a predictive model of purchasing performance based on information contained with the database.

62. The method of claim 6 wherein the information stored on the chip card contains information identifying the specific product manufacturer or vendor, a product identification, and an indicator of how many displays of the advertisement information were performed prior to the customer's first purchase of the item or items advertised.

63. The method of claim 62 wherein there is further stored a value that indicates the generic class or classes into which a particular product falls.

64. The method of claim 62 wherein there is further stored a value that indicates a price range into which the selling price of a particular product falls.

65. The method of claim 62 wherein there is further stored a value that indicates the version of the advertising information downloaded to the card to distinguish from among a plurality of versions of the advertising information, each of the versions targeted to a different user type.

66. The method of claim 6 wherein the information characterizing the user comprises a user profile generated from demographic, psychographic, or other specific product preference information along with a user identification.

67. The method of claim 6 wherein the user identification is encoded to hide the identity of the user from a database used for tracking the purchasing activity of the user.

68. The method of claim 67, wherein the encoding is done so that there exists a substantially one-to-one mapping between the encoded user identification and the actual user identification.

69. The method of claim 2 or 5 wherein the user identification information is a credit or debit card number.

70. The method of claim 68 wherein the user identification information is a credit or debit card number.

71. The method of claim 70 wherein the card type and card issuer fields of the user identification information are left unencoded.

72. The method of claim 10 wherein the transaction is a purchase-less transaction such as an ATM transaction.

73. The method of claim 2 or 5 wherein the advertisement information is advertising.

74. The method of claim 2 or 5 wherein the advertisement information is one or more sales promotions.

75. The method of claim 57, wherein there is at least one decision rule based on the current date or time.

76. The method of claim 75, wherein the decision rule based on date or time calls for downloading of advertisement information when the current date or time is within a predetermined date or time interval for which the advertisement information is relevant.

77. The method of claim 2 or 5, wherein the advertisement information is stored in a memory within the display.

78. The method of claim 2 or 5, wherein the advertisement information is stored in a memory on the chip card separate from the display.
